(19) United States
(12) Patent Application Publication
(10) Pub. No.: US 2024/0364823 A1
(43) Pub. Date: Oct. 31, 2024

(54) MEDIA CONVEYING APPARATUS, IMAGE PROCESSING SYSTEM, AND MEDIA CONVEYING METHOD

(71) Applicant: PFU LIMITED, Kahoku-shi (JP)

(72) Inventor: Katsunori Aoyama, Kahoku-shi (JP)

(21) Appl. No.: 18/643,838

(22) Filed: Apr. 23, 2024

(30) Foreign Application Priority Data
Apr. 28, 2023 (JP) 2023-074898

(51) Int. Cl. H04N 1/00

(52) U.S. Cl. CPC H04N 1/0057; H04N 1/00925

(57) ABSTRACT

A media conveying apparatus includes circuitry to set setting information regarding an input image generation process, a conveyor to convey a plurality of media sequentially, and an imager to image each of the plurality of media according to the setting information to obtain an input image. The circuitry further determines, based on the input image, whether the setting information is compatible with the medium imaged in the input image. When the circuitry determines that the setting information is incompatible with the medium imaged in the input image, the circuitry suspends conveying subsequent media and outputs information about the determination result.

### CROSS-REFERENCE TO RELATED APPLICATIONS

This patent application is based on and claims priority pursuant to 35 U.S.C. § 119 (a) to Japanese Patent Application No. 2023-074898, filed on Apr. 28, 2023, in the Japan Patent Office, the entire disclosure of which is hereby incorporated by reference herein.

### BACKGROUND

The present disclosure relates to a media conveying apparatus, an image processing system, and a media conveying method.

Currently, media conveying apparatuses such as a scanner, which scans a plurality of media to generate images while sequentially conveying the media, have been used for imaging of various types of media in a wide variety of applications. The image quality required of such a media conveying apparatus differs depending on, for example, its purpose and the type of media to be read. In general, in the media conveying apparatus, various setting information regarding imaging processing of the media or image processing, such as resolution or color, can be set in order to generate an appropriate image according to, for example, the application or type of media. If incorrect setting information is set, it is necessary for the user to take out the medium whose image has been generated according to the incorrect setting information from a plurality of media having been conveyed and imaged, and then to conduct conveyance and imaging again.

A known image reading apparatus allows a document reading mode to be registered for each page before reading the document, and reads the page in the reading mode corresponding to the page.

### SUMMARY

In one aspect, a media conveying apparatus includes circuitry to set setting information regarding an input image generation process, a conveyor to convey a plurality of media sequentially, and an imager to image each of the plurality of media according to the setting information to obtain an input image. The circuitry further determines, based on the input image, whether the setting information is compatible with a medium from the plurality of media imaged in the input image. When the circuitry determines that the setting information is incompatible with the medium imaged in the input image, the circuitry suspends conveying a subsequent media from the plurality of media and outputs information about the determination result.

In another aspect, an image processing system includes a media conveying apparatus including first circuitry, and an information processing apparatus including second circuitry. The first circuitry or the second circuitry sets setting information regarding an input image generation process. The media conveying apparatus includes a conveyor to convey a plurality of media sequentially, and an imager to image each of the plurality of media according to the setting information to obtain an input image. The first circuitry or the second circuitry determines, based on the input image, whether the setting information is compatible with a medium from the plurality of media imaged in the input image. When the setting information is determined to be incompatible with the medium imaged in the input image, the first circuitry suspends conveying a subsequent media from the plurality of media. When the setting information is determined to be incompatible with the medium imaged in the input image, the first circuitry or the second circuitry outputs information about a determination result that the setting information is incompatible with the medium imaged in the input image.

In another aspect, a media conveying method includes conveying a plurality of media sequentially by a conveyor; imaging, with an imager, each of the plurality of media according to the setting information to obtain an input image; determining, based on the input image, whether the setting information is compatible with a medium from the plurality of media imaged in the input image; suspending conveying a subsequent media from the plurality of media based on a determination result indicating that the setting information is incompatible with the medium imaged in the input image; and outputting information about the determination result based on the determination result.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of an image processing system according to an embodiment;

FIG. 2 is a perspective view illustrating a media conveying apparatus according to an embodiment;

FIG. 3 is a diagram illustrating a conveyance passage inside the media conveying apparatus of FIG. 2;

FIG. 4 is a schematic block diagram illustrating a configuration of the media conveying apparatus of FIG. 2;

FIG. 5 is a schematic diagram illustrating a data structure of a result table according to an embodiment;

FIG. 6 is a schematic diagram illustrating setting information according to an embodiment;

FIG. 7 is a diagram illustrating a schematic configuration of a first storage device and a first processing circuit according to an embodiment;

FIG. 8 is a block diagram illustrating a schematic configuration of an information processing apparatus according to an embodiment;

FIG. 9 is a flowchart illustrating an example of the operation of a media reading process;

FIG. 10 is a flowchart illustrating an example of the operation of a media reading process;

FIG. 11 is a schematic diagram illustrating an example of first notification data;

FIG. 12 is a schematic diagram illustrating an example of second notification data;

FIG. 13 is a block diagram illustrating a schematic configuration of a first processing circuit in a media conveying apparatus according to another embodiment;

FIG. 14 is a diagram illustrating a schematic configuration of a second storage device and a second processing circuit in an information processing apparatus according to still another embodiment; and

FIG. 15 is a block diagram illustrating a schematic configuration of a second processing circuit in an information processing apparatus according to still another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a media conveying apparatus, an image processing system, a media conveying method, and a control program according to embodiments of the present disclosure with reference to the drawings. The embodiments described below are illustrative and do not limit the present disclosure. Thus, numerous additional modifications and variations are possible in light of the above teachings. For example, elements and/or features of different illustrative embodiments may be combined with each other and/or substituted for each other within the scope of the present invention.

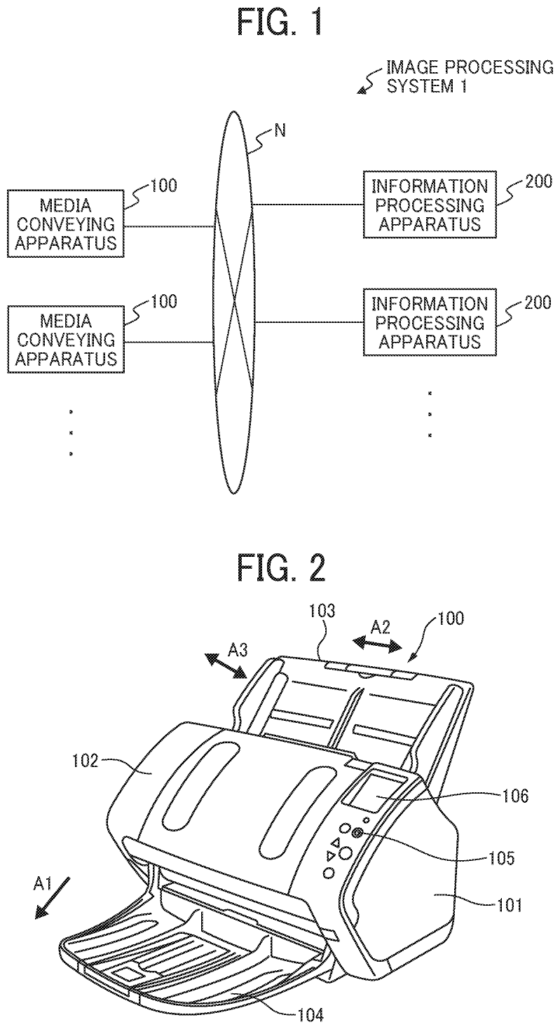

FIG. 1 is a diagram illustrating a schematic configuration of an image processing system 1 according to an embodiment.

As illustrated in FIG. 1, the image processing system 1 includes one or a plurality of media conveying apparatuses 100 and one or a plurality of information processing apparatuses 200. The media conveying apparatus 100 and the information processing apparatus 200 are communicatively connected to each other via a network N. The network N is, for example, the Internet or an intranet.

The media conveying apparatus 100 is an Auto Document Feeder (ADF) type scanner device that images a medium such as a document while conveying the media, for example. The media are, for example, sheets of plain paper, sheets of thin paper, sheets of thick paper, or cards. The media include various types of media such as receipts, business cards, invoices, and delivery notes. Alternatively, the media conveying apparatus 100 may be, for example, a facsimile machine, a copier, or a multifunction peripheral (MFP).

The information processing apparatus 200 is, for example, a personal computer, a notebook personal computer, a tablet computer, or a smartphone. The information processing apparatus 200 may be a server provided in a cloud network.

FIG. 2 is a perspective view of the media conveying apparatus 100 according to the present embodiment.

The media conveying apparatus 100 includes a lower housing 101, an upper housing 102, a receptacle 103, a discharge table 104, a first input device 105, a first display device 106, and the like.

The upper housing 102 is disposed at a position covering the upper surface of the media conveying apparatus 100, and is engaged with the lower housing 101 via a hinge so that upper housing 102 can be opened and closed at the time of jamming a medium or clearing of the inside of the media conveying apparatus 100.

The receptacle 103 is engaged with the lower housing 101 such that the media to be conveyed can be placed on the receptacle 103. The discharge table 104 is engaged with the lower housing 101 such that the media discharged from the discharge port can be placed on the discharge table 104.

The first input device 105 includes an input device such as buttons and an interface circuit that acquires signals from the input device. The first input device 105 receives an input operation performed by a user and outputs an operation signal corresponding to the input operation performed by the user. The first display device 106 includes a display having liquid crystal organic EL (Electro-Luminescence), and etc., and an interface circuit that outputs image data to the display, to display the image data on the display.

In FIG. 2, an arrow A1 indicates the media conveying direction, an arrow A2 indicates the width direction perpendicular to the media conveying direction, and an arrow A3 indicates the height direction perpendicular to the media conveying direction and the width direction. In the following, upstream is upstream in the media conveying direction A1, and downstream is downstream in the media conveying direction A1.

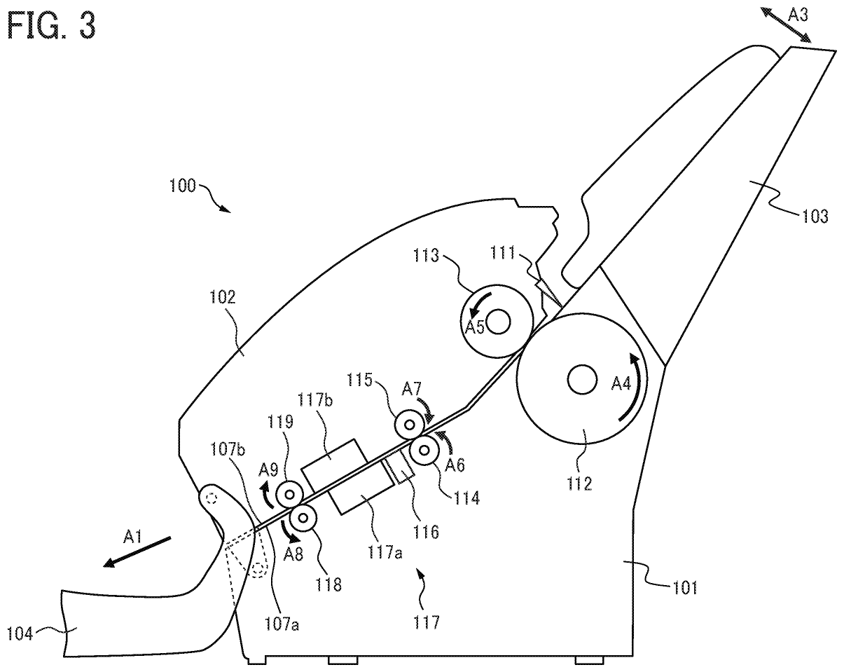

FIG. 3 is a diagram illustrating a conveyance passage inside the media conveying apparatus 100 according to the present embodiment.

The conveyance passage inside the media conveying apparatus 100 includes a first media sensor 111, a feeding roller 112, a separation roller 113, a first conveyance roller 114, a second conveyance roller 115, a second media sensor 116, an imaging device 117, and a third conveyance roller 118, a fourth conveyance roller 119, and the like. The number of each roller is not limited to one, and the number of each roller may be plural, respectively. In such a case, each roller is disposed side by side at intervals in the width direction A2, respectively. The feeding roller 112, the separation roller 113, the first conveyance roller 114, the second conveyance roller 115, the third conveyance roller 118, and the fourth conveyance roller 119 are examples of a conveyor, and sequentially convey a plurality of media.

The media conveying apparatus 100 has a so-called straight path. The upper surface of the lower housing 101 forms a lower guide 107a for the media conveying path, and the lower surface of the upper housing 102 forms an upper guide 107b for the media conveying path.

The first media sensor 111 is disposed upstream from the feeding roller 112 and the separation roller 113. The first media sensor 111 includes a contact detection sensor and detects whether a medium is placed on the receptacle 103. The first media sensor 111 generates and outputs a first media signal whose signal value changes depending on whether a medium is placed on the receptacle 103. The first media sensor 111 is not limited to a contact detection sensor. The first media sensor 111 may be any other sensor such as an optical detection sensor having the capability of detecting the presence of a medium.

The feeding roller 112 is provided in the lower housing 101 and sequentially feeds the media placed on the receptacle 103 from the bottom. The separation roller 113 is a so-called brake roller or retard roller, and is provided in the upper housing 102 and is disposed opposite to the feeding roller 112. The feeding roller 112 and the separation roller 113 function as a separation unit that separates the media.

The first conveyance roller 114 and the second conveyance roller 115 are disposed downstream from the feeding roller 112 and the separation roller 113 and opposite to each other, and convey the media fed by the feeding roller 112 and the separation roller 113 to the imaging device 117.

The second media sensor 116 is disposed downstream from the first conveyance roller 114 and the second conveyance roller 115 and upstream from the imaging device 117, and detects the media conveyed to that position. The second media sensor 116 includes a light emitter and a light receiver provided on one side with respect to the media conveying path (for example, the lower housing 101), and a light guide tube provided on a position opposite to the light emitter and the light receiver with the media conveying path in between (for example, the upper housing 102). The light emitter is a light emitting diode (LED) or the like, and emits light toward the media conveying path. By contrast, the light receiver is, for example, a photodiode and receives the light that is emitted by the light emitter and guided by the light guide tube. When the medium is present at a position opposite to the second media sensor 116, the light emitted from the light emitter is blocked by the media, and therefore the light receiver does not detect the light emitted from the light emitter. Based on the intensity of the light received, the light receiver generates and outputs a second media signal whose signal value changes between states in which the medium exists and does not exist at the position of the second media sensor 116.

A reflective member such as a mirror may be used instead of the light guide tube. Further, the light emitter and the light receiver may be provided opposite to each other with the media conveying path in between. Further, the second media sensor 116 may detect the medium using a contact detection sensor or the like that flows a predetermined current when the medium is in contact or not in contact therewith.

The imaging device 117 is an example of an imager. The imaging device 117 is disposed downstream from the first conveyance roller 114 and the second conveyance roller 115 and upstream from the third conveyance roller 118 and the fourth conveyance roller 119. The imaging device 117 includes a first imaging device 117a and a second imaging device 117b. The first imaging device 117a and the second imaging device 117b are disposed near the media conveying path and opposite to each other with the conveying path in between.

The first imaging device 117a includes a light source and a contact image sensor (CIS) line sensor. The CIS line sensor employs an equal-magnification optical system and includes complementary metal oxide semiconductor (CMOS) imaging elements aligned linearly in the main-scanning direction. The first imaging device 117a further includes a lens that forms an image on the imaging elements and an analog-to-digital (A/D) converter. The A/D converter amplifies the electric signals output from the imaging elements and performs analog-to-digital (A/D) conversion. The first imaging device 117a obtains an input image by imaging the front side of each of the media sequentially conveyed by the conveyor, and outputs the input image.

Similarly, the second imaging device 117b includes a light source and a CIS line sensor employing the equal-magnification optical system and including CMOS imaging elements aligned linearly in the main-scanning direction. The second imaging device 117b further includes a lens that forms an image on the imaging elements and an A/D converter. The A/D converter amplifies the electric signals output from the imaging elements and performs A/D conversion. The second imaging device 117b obtains an input image by imaging the back side of each of the media sequentially conveyed by the conveyor, and outputs the input image.

Alternatively, the media conveying apparatus 100 may include either the first imaging device 117a or the second imaging device 117b to read only one side of the media. The CIS line sensor may, instead of the CIS line sensor employing the equal-magnification optical system and including CMOS imaging element, employ the equal-magnification optical system and includes charge-coupled devices (CCD) imaging elements. Alternatively, a line sensor employing a reduction optical system and including a CMOS or CCD imaging element may be used.

Further, the first imaging device 117a has a backing provided at a position opposite to the line sensor of the second imaging device 117b with the media conveying path in between. The second imaging device 117b has a backing provided at a position opposite to the line sensor of the first imaging device 117a with the media conveying path in between. Each backing has an opposing surface that is opposite to each line sensor. The opposing surface of each backing has, for example, a white color. Each backing functions as a white reference for image correction such as shading based on an image signal obtained by imaging an image of the opposing surface. Each backing is movable between an opposing position where each opposing surface is opposite to each line sensor and a non-opposing position where each opposing surface is deviated from the opposing position. When an image is generated in a state where the backing is disposed in the opposing position, the background area where the medium is absent includes the backing, and pixels within that area have a white color. By contrast, the background area of the image generated in a state where the backing is disposed in the non-opposing position includes their respective bottom surfaces (walls) of the imaging devices, and pixels within that area have a black color.

The third conveyance roller 118 and the fourth conveyance roller 119 are disposed downstream from the imaging device 117 and opposite to each other, and discharge the media conveyed by the first conveyance roller 114 and the second conveyance roller 115 onto the discharge table 104.

The media placed on the receptacle 103 are conveyed between the lower guide 107a and the upper guide 107b in the media conveying direction A1 by the feeding roller 112 rotating in the direction of the arrow A4 in FIG. 3. The separation roller 113 rotates or stops in the direction of the arrow A5 in FIG. 3 when conveying the media. Due to the action of the feeding roller 112 and separation roller 113, when a plurality of media is placed on the receptacle 103, only the medium in contact with the feeding roller 112 among the media placed on the receptacle 103 is separated. This prevents the conveying of the media other than the separated media. In short, the multiple feeding is prevented.

The medium is fed between the first conveyance roller 114 and the second conveyance roller 115 while being guided by the lower guide 107a and the upper guide 107b. The medium is fed between the first imaging device 117a and the second imaging device 117b by the first conveyance roller 114 rotating in the direction of the arrow A6 in FIG. 3 and the second conveyance roller 115 rotating in the direction of the arrow A7 in FIG. 3. The media read by the imaging device 117 are discharged onto the discharge table 104 by the third conveyance roller 118 rotating in the direction of the arrow A8 in FIG. 3 and the fourth conveyance roller 119 rotating in the direction of the arrow A9 in FIG. 3.

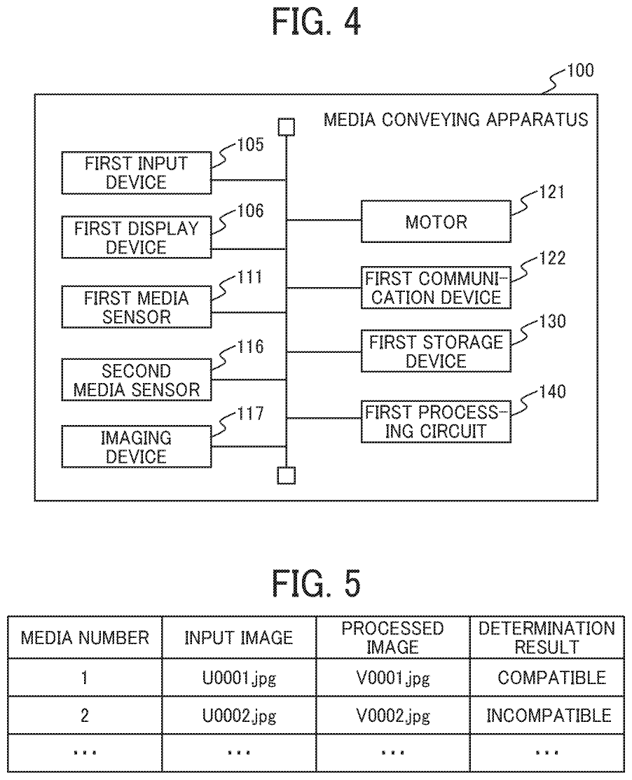

FIG. 4 is a schematic block diagram illustrating a configuration of the media conveying apparatus 100 according to the present embodiment.

In addition to the configuration described above, the media conveying apparatus 100 includes a motor 121, a first communication device 122, a first storage device 130, a first processing circuit 140, and the like.

The motor 121 includes one or a plurality of motors. The motor 121 rotates the feeding roller 112, the separation roller 113, the first conveyance roller 114, the second conveyance roller 115, the third conveyance roller 118, and the fourth conveyance roller 119 in response to a control signal from the first processing circuit 140 to perform the conveyance operation of the media. One of the first conveyance roller 114 and the second conveyance roller 115 may be a driven roller that rotates following the other roller. Furthermore, one of the third conveyance roller 118 and the fourth conveyance roller 119 may be a driven roller that rotates following the other roller.

The first communication device 122 includes an antenna that transmits and receives wireless signals, and a wireless communication interface circuit for transmitting and receiving signals through a wireless communication line according to a communication protocol such as a wireless local area network (LAN) protocol. The first communication device 122 communicates with the information processing apparatus 200, and according to an instruction from the first processing circuit 140, is communicatively connected to the information processing apparatus 200 to transmit and receive various images and information. The first communication device 122 may include a wired communication interface circuit supporting a communication protocol such as the Transmission Control Protocol/Internet Protocol (TCP/IP), and may be connected to the information processing apparatus 200 via a network. The first communication device 122 may have an interface circuit compatible with a serial bus such as the Universal Serial Bus (USB) and may be connected to the information processing apparatus 200 via a wired cable such as a USB cable.

The first storage device 130 includes memories such as a random-access memory (RAM) and a read-only memory (ROM); a fixed disk device such as a hard disk; or a portable memory such as a flexible disk or an optical disk. The first storage device 130 stores, for example, computer programs, databases, and tables used for various processes performed by the media conveying apparatus 100. The computer programs may be installed in the first storage device 130 using a known setup program or the like from a computer-readable portable recording medium. The portable recording medium is, for example, the compact disc read only memory (CD-ROM), the digital versatile disc read only memory (DVD-ROM), and so on. Further, the computer program may be distributed from a server or the like and installed in the first storage device 130. Furthermore, the first storage device 130 stores a result table as data. Details of the result table is described later.

The first processing circuit 140 operates according to a program stored in the first storage device 130 in advance. The first processing circuit 140 is, for example, a central processing unit (CPU). Alternatively, as the first processing circuit 140, for example, a digital signal processor (DSP), a large scale integration (LSI), an application-specific integrated circuit (ASIC), or a field-programmable gate array (FPGA) may be used.

The first processing circuit 140 is connected to the first input device 105, the first display device 106, the first media sensor 111, the second media sensor 116, the imaging device 117, the motor 121, the first communication device 122, the first storage device 130, and the like, and controls each of these units. The first processing circuit 140 sets setting information regarding an input image generation process designated by the user via the first input device 105 or the first communication device 122. The information regarding the input image generation process is information regarding at least one of imaging processing and image processing. The first processing circuit 140 performs drive control of the motor 121, imaging control of the imaging device 117, and the like, according to the set setting information, and acquires an input image. The first processing circuit 140 also determines whether the setting information is compatible with the medium imaged in the input image (an image of the medium included in the input image). Further, in a case where the first processing circuit 140 determines that the setting information is incompatible, the first processing circuit 140 suspends conveying subsequent media. In this disclosure, the expression like “setting information is compatible with a medium” is synonymous with the expression like “setting information matches a medium.”

FIG. 5 is a schematic diagram illustrating a data structure of the result table according to the present embodiment.

As illustrated in FIG. 5, in the result table, information such as the media number, the input image, the processed image, and the determination result are stored in association with each other for each medium conveyed by the media conveying apparatus 100. The media number is a number for identifying the medium to be conveyed, and indicates the order in which each medium is conveyed among a bundle of media placed on the receptacle 103 and conveyed in sequence. The input image is an image of the medium captured according to the setting information. The processed image is an image generated by performing image processing on the input image according to the setting information. The determination result indicates “compatible” or “incompatible” as a result of determining whether the setting information is compatible with the medium imaged in the input image. The items corresponding to each medium in the result table are initialized at the start of the media reading and is added or updated each time the medium is conveyed.

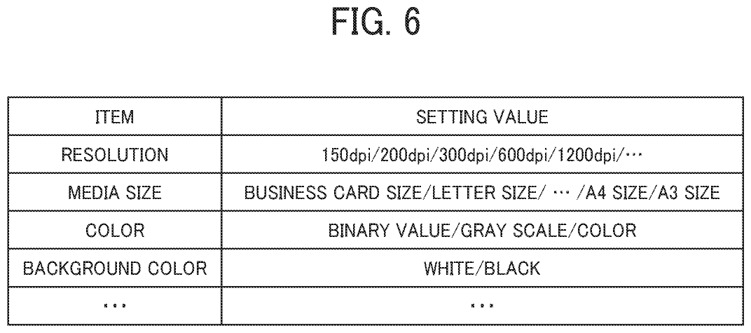

FIG. 6 is a schematic diagram illustrating the setting information according to the present embodiment.

As illustrated in FIG. 6, the setting information is information on imaging processing or image processing, and is information for specifying, for example, content of the operation of the media conveying apparatus 100 for imaging the media or image processing to be executed on the obtained images. Items specified by the setting information include resolution, media size, color, and background color.

Resolution, media size, color, background color, and the like, are settings regarding imaging processing. Further, resolution, media size, color, and the like, are settings regarding image processing.

The resolution is the setting of the resolution of the image to be generated, and the setting value of the resolution is, for example, 150 dpi (Dots Per Inch), 200 dpi, 300 dpi, 600 dpi, or 1200 dpi. The media conveying apparatus 100 can generate an image with a set resolution by setting imaging processing conditions including the media conveying speed, the imaging timing (time interval) of the imaging device 117, and the positions of the imaging elements in the line sensor to be used. Further, the media conveying apparatus 100 can generate an image with the set resolution by executing, in the image processing, thinning or interpolation of the image generated in the imaging processing.

The media size is the setting of the size of the medium included in the image to be generated. Examples of setting value of the media size include business card size, letter size, A4 size, and A3 size. The media conveying apparatus 100 can generate an image including a medium of the set media size by setting, for example, the timing at which the imaging device 117 finishes the imaging, and the position of the imaging element in the line sensor used for the imaging in the imaging processing. In addition, the media conveying apparatus 100 can generate an image including a medium of the set media size by executing, in the image processing, cropping of the image generated in the imaging processing.

The color is the setting of the color of an image to be generated. Examples of the setting value of the color include a binary value, gray scale, and a color. The media conveying apparatus 100 can change the color of the image to be generated by setting the color of the light emitted by the light source of the imaging device 117, the gradation range converted by the A/D converter, and the like in the imaging processing. Further, the media conveying apparatus 100 can change the color of the image to be generated by executing, in the image processing, grayscale conversion or binarization of the color image generated in the imaging processing.

The background color is the setting of the color of a portion of the image to be generated other than the medium, and white, black, and the like are set as the setting value of the background color. The media conveying apparatus 100 can change the background color in the image to be generated by switching the position of the backing (opposing position/non-opposing position) of the imaging device 117 in the imaging processing.

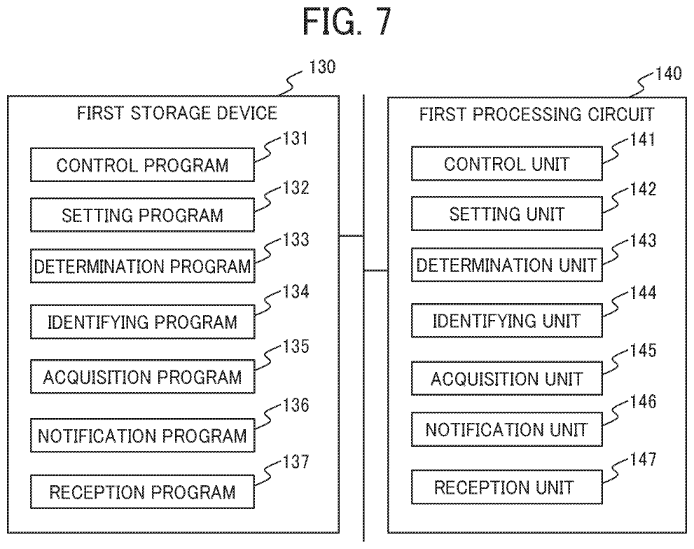

FIG. 7 is a diagram illustrating a schematic configuration of the first storage device 130 and the first processing circuit 140 according to the present embodiment.

As illustrated in FIG. 7, the first storage device 130 stores a control program 131, a setting program 132, a determination program 133, an identifying program 134, an acquisition program 135, a notification program 136, and a reception program 137. Each of these programs is a functional module implemented by software operating on a processor. The first processing circuit 140 reads programs stored in the first storage device 130 and operates according to the programs read, thereby functioning as a control unit 141, a setting unit 142, a determination unit 143, an identifying unit 144, an acquisition unit 145, a notification unit 146 and a reception unit 147.

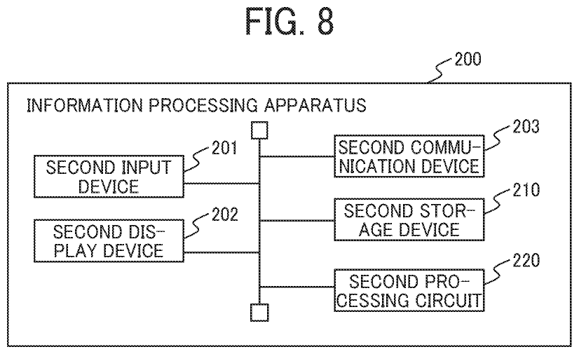

FIG. 8 is a schematic block diagram illustrating a configuration of the information processing apparatus 200 according to the present embodiment.

The information processing apparatus 200 includes a second input device 201, a second display device 202, a second communication device 203, a second storage device 210, and a second processing circuit 220.

The second input device 201 includes an input device such as a keyboard and a mouse, and an interface circuit that acquires signals from the input device, and the second input device 201 outputs a signal corresponding to the operation performed by the user to the second processing circuit 220.

The second display device 202 has a display including a liquid crystal, an organic EL, and the like, and an interface circuit that outputs image data to the display, and the second display device 202 displays various information on the display according to an instruction from the second processing circuit 220.

The second communication device 203 includes an antenna that transmits and receives wireless signals, and a wireless communication interface circuit that transmits and receives signals through a wireless communication line according to a predetermined communication protocol such as the wireless LAN protocol. The second communication device 203 communicates with the media conveying apparatus 100, and according to an instruction from the second processing circuit 220, is communicatively connected to the media conveying apparatus 100 to transmit and receive various images and information. The second communication device 203 may have a wired communication interface circuit supporting a communication protocol such as the TCP/IP, and may be connected to the media conveying apparatus 100 via a network. Further, the second communication device 203 may have an interface circuit compatible with a serial bus such as the USB, and may be connected to the media conveying apparatus 100 via a wired cable such as the USB cable.

The second storage device 210 includes memories such as a RAM or ROM; a fixed disk device such as a hard disk; or a portable storage device such as a flexible disk or an optical disk. The second storage device 210 stores, for example, computer programs, databases, tables, used in various processes performed by the information processing apparatus 200. The computer program may be installed in the second storage device 210 from a computer-readable portable recording medium such as the CD-ROM or the DVD-ROM using a known setup program or the like. Further, the computer program may be distributed from a server or the like and installed in the second storage device 210.

The second processing circuit 220 operates according to a program stored in the second storage device 210 in advance. The second processing circuit 220 is, for example, a CPU. A DSP, LSI, ASIC, FPGA, and the like may be used as the second processing circuit 220.

The second processing circuit 220 is connected to the second input device 201, the second display device 202, the second communication device 203, the second storage device 210, and the like, and controls each of these units. The second processing circuit 220 performs data transmission/reception control with the media conveying apparatus 100 via the second communication device 203, input control of the second input device 201, display control of the second display device 202, and the like.

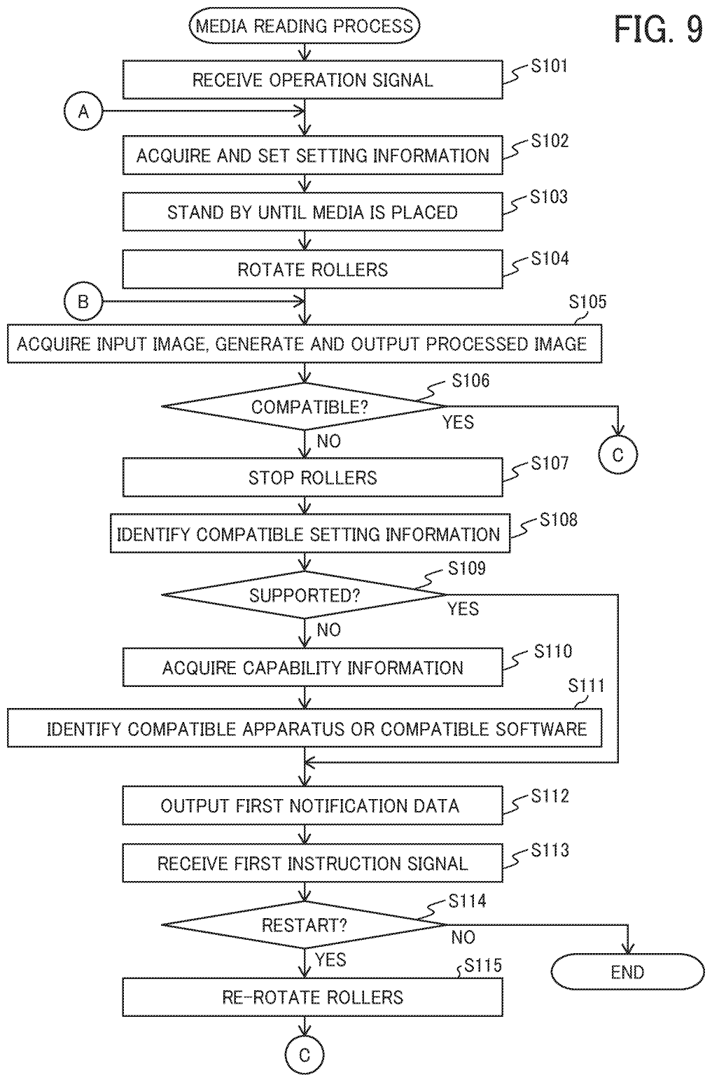

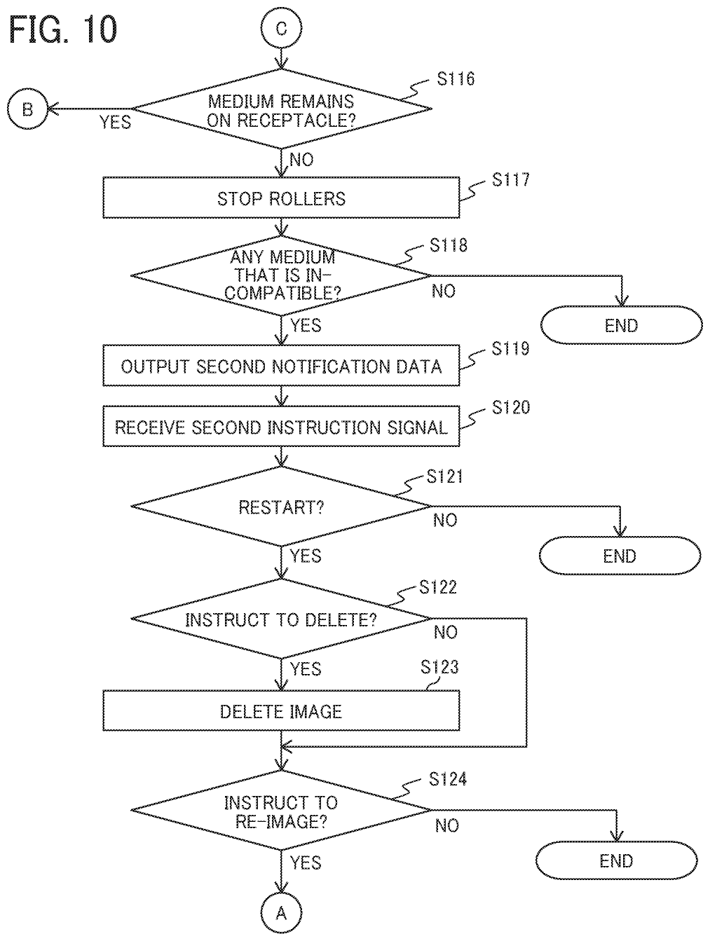

FIGS. 9 and 10 are flowcharts illustrating example operations in the media reading process according to the present embodiment.

A description is given below of example operations in the media reading process of the media conveying apparatus 100 according to the present embodiment, with reference to the flowchart of FIGS. 9 and 10. The operation process described below is mainly executed by the first processing circuit 140 in cooperation with each component of the media conveying apparatus 100 according to a program pre-stored in the first storage device 130.

The control unit 141 stands by until a reading instruction to read media is input by the user using the first input device 105 or the information processing apparatus 200 and an operation signal indicating the reading the medium is received from the first input device 105 or the first communication device 122 (step S101). The operation signal includes setting information regarding imaging processing or image processing designated by the user using the first input device 105 or the information processing apparatus 200 along with a reading instruction.

Next, the setting unit 142 acquires the setting information included in the operation signal and sets the setting information in, for example, the imaging device 117 and motor 121 to generate an input image according to the settings specified by the setting information (step S102). The setting information may not be designated together with the reading instruction, and may be set in advance and stored in the first storage device 130 before the reading instruction is input. In that case, the setting unit 142 acquires the setting information by reading the setting information from the first storage device 130. Further, the control unit 141 sets (initializes) the media number of the medium to be conveyed to 1.

Next, the control unit 141 stands by until the media are placed on the receptacle 103 (step S103). The control unit 141 acquires a first media signal from the first media sensor 111 and determines whether media are placed on the receptacle 103 based on the acquired first media signal.

Next, the control unit 141 drives the motor 121 to rotate the feeding roller 112, the separation roller 113, the first conveyance roller 114, the second conveyance roller 115, the third conveyance roller 118, and/or the fourth conveyance roller 119 (step S104). Thus, the control unit 141 controls the above-mentioned elements to convey the media placed on the receptacle 103. The control unit 141 controls the motor 121 to rotate at a speed that allows generation of an image with the resolution specified by the setting information to generate the input image according to the setting information acquired in step S102.

Next, the control unit 141 acquires the input image from the imaging device 117, generates a processed image based on the input image, and outputs the processed image by transmitting the processed image to the information processing apparatus 200 via the first communication device 122 (step S105).

For example, the control unit 141 determines whether the leading end of the medium has passed the position of the second media sensor 116 based on the second media signal received from the second media sensor 116. The control unit 141 acquires the second media signal periodically from the second media sensor 116 and determines that the leading end of the medium has passed the position of the second media sensor 116 when the signal value of the second media signal changes from a value indicating the absence of a medium to a value indicating the presence of a medium. The control unit 141 controls the imaging device 117 to start imaging when the leading end of the medium has passed the position of the second media sensor 116. The control unit 141 controls the imaging device 117 to generate the input image according to the setting information acquired in step S102.

Thereafter, the control unit 141 controls the imaging device 117 to end imaging when the medium has been conveyed by the amount of the media size indicated by the setting information acquired in step S102 plus the margin. The control unit 141 may control the imaging device 117 to end imaging when the rear end of the medium has passed through the imaging position of the imaging device 117. For example, the control unit 141 determines whether the rear end of the medium has passed the position of the second media sensor 116 based on the second media signal received from the second media sensor 116. The control unit 141 acquires the second media signal periodically from the second media sensor 116 and determines that the leading end of the medium has passed the position of the second media sensor 116 when the signal value of the second media signal changes from a value indicating the presence of a medium to a value indicating the absence of a medium. The control unit 141 determines that the rear end of the medium has passed the imaging position of the imaging device 117 when a first predetermined time has elapsed since the rear end of the medium passed the position of the second media sensor 116. The first predetermined time is set to the time taken for the medium to move from the second media sensor 116 to the imaging position.

The control unit 141 acquires the input image from the imaging device 117 every time the imaging device 117 generates a predetermined line of the input image, and synthesizes the input images when the imaging device 117 ends imaging. The control unit 141 may collectively acquire input images for all lines at a time when the imaging device 117 ends the imaging. The control unit 141 generates the processed image by performing the image processing on the input image according to the setting information acquired in step S102. In a case where no image processing needs to be performed, the control unit 141 uses the input image itself as the processed image. The processed image is an example of an image based on the input image. The control unit 141 stores the media number of the conveyed media, the acquired input image, and the generated processed image in the result table in association with each other.

Further, the control unit 141 transmits the processed image along with the media number of the processed image to the information processing apparatus 200. The second processing circuit 220 of the information processing apparatus 200 receives the processed image and the media number from the media conveying apparatus 100 via the second communication device 203, and stores the received processed image and the received media number in the second storage device 210 in association with each other.

Next, the determination unit 143 determines whether the setting information set by the user is compatible with the medium (characteristics of the input image) included in the input image based on the input image (step S106).

For example, the determination unit 143 uses known optical character recognition (OCR) technology to detect characters from the input image. The determination unit 143 determines that the setting information is incompatible with the medium imaged in the input image in a case where the ratio of the number of under-threshold-pixel characters to the number of all detected characters is equal to or greater than a threshold ratio. An under-threshold-pixel character is a character whose pixel count is less than a pixel number threshold. The threshold pixel number and the threshold ratio for character number are set in advance.

The determination unit 143 may determine whether the setting information is compatible with the medium imaged in the input image based on the character size (point) of each detected character on the medium. In that case, the resolution for imaging a paracellular character size is preset in the first storage device 130 for each character size. For example, in a case where the character size is less than 8 points, the resolution is set to 400 dpi or more. In a case where the character size is 8 points or more and 10 points or less, the resolution is set to 300 dpi or more. In a case where the character size is greater than 10 points, the resolution is set to 200 dpi or more. The determination unit 143 identifies the character size from the pixel number of each detected character and the resolution included in the setting information, and determines whether the resolution indicated in the setting information satisfies the resolution of the identified character size. The determination unit 143 determines that the setting information is incompatible with the medium imaged in the input image in a case where the ratio of the number of unsatisfied-resolution characters to the number of all detected characters is equal to or greater than the threshold ratio. An unsatisfied-resolution character is a character in which the resolution indicated in the setting information does not satisfy the resolution set for the character size.

Further, the determination unit 143 determines whether the input image includes image data other than text or ruled lines. The determination unit 143 determines that the input image includes image data other than text or ruled lines in a case where the variation degree of the gradation values of pixels in the input image is equal to or greater than a variation threshold. The gradation value is a brightness value, a color value, or the like. The variation degree herein is variance, standard deviation, or the like. By contrast, the determination unit 143 determines that the input image does not include image data other than text or ruled lines in a case where the variation degree of the gradation values of pixels in the input image is less than the variation threshold.

The determination unit 143 may determine whether the input image includes image data other than text or ruled lines by a discriminator that has been pre-trained to output information indicating whether the image includes image data other than text or ruled lines in a case where the image is input. The discriminator is pre-trained using a plurality of images including various types of media, for example, by deep learning, and is stored in the first storage device 130 in advance. The determination unit 143 inputs the input image to a discriminator, and determines whether the input image includes image data other than text or ruled lines based on information output from the discriminator.

The determination unit 143 determines that the setting information is incompatible with the medium imaged in the input image in a case where the determination unit 143 determines that the input image includes image data other than text or ruled lines and the resolution indicated in the setting information is equal to or less than a predetermined first resolution threshold (for example, 200 dpi). By contrast, the determination unit 143 determines that the setting information is incompatible with the medium imaged in the input image in a case where the determination unit 143 determines that the input image does not include image data other than text or ruled lines and the resolution indicated in the setting information is equal to or more than a predetermined second resolution threshold (for example, 600 dpi).

The determination unit 143 determines that the setting information is incompatible with the medium imaged in the input image in a case where the determination unit 143 determines that the input image includes image data other than text or ruled lines, and the color indicated in the setting information is binary. By contrast, the determination unit 143 determines that the setting information is incompatible with the medium imaged in the input image in a case where the determination unit 143 determines that the input image does not include image data other than text or ruled lines, and the color indicated in the setting information is a color.

Further, the determination unit 143 detects edge pixels from the input image using a known image processing technique, and detects the largest area among the areas surrounded by the edge pixels as the medium area. The determination unit 143 calculates the size of the medium imaged in the input image from the number of pixels included in the detected medium area and the resolution at which the input image is generated. The determination unit 143 determines that the setting information is incompatible with the medium imaged in the input image in a case where the calculated size and the media size indicated in the setting information do not match. The determination unit 143 determines that not the entire medium is included in the input image generated according to the setting information and the setting information is incompatible with the medium imaged in the input image in a case where the detected medium area in the input image overlaps with the bottom end of the input image.

Further, the determination unit 143 extracts pixels having gradation values within a range that is considered to be show-through in the input image in which one side of the medium is imaged as candidate pixels. The determination unit 143 extracts pixels whose brightness values are equal to or less than a predetermined brightness threshold (pixels that are close to black) in the input image in which the other side of the medium is imaged as low-brightness pixels. The determination unit 143 determines that the show-through of the medium has occurred in a case where the ratio of the number of low-brightness pixels extracted at the position corresponding to the candidate pixels to the number of extracted candidate pixels is equal to or greater than a predetermined low-brightness pixel ratio threshold. The determination unit 143 determines that the setting information is incompatible with the medium imaged in the input image in a case where the determination unit 143 determines that the show-through of the medium has occurred and the background color indicated in the setting information is white.

The determination unit 143 stores the determination result in a result table in association with the media number of the conveyed medium, that is, in association with the input image and the processed image based on the input image. The determination unit 143 determines that the setting information is compatible with the medium imaged in the input image, and moves the process to step S116 in a case where the determination unit 143 does not determine that the setting information is incompatible with the medium imaged in the input image.

By contrast, in a case where the determination unit 143 determines that the setting information is incompatible with the medium imaged in the input image, the control unit 141 stops the motor 121 to stop the feeding roller 112, the separation roller 113, the first conveyance roller 114, the second conveyance roller 115, the third conveyance roller 118, and/or the fourth conveyance roller 119. As a result, the control unit 141 suspends conveying subsequent media (step S107).

The control unit 141 suspends conveying subsequent media after the leading end of the medium has passed the position of the discharge port and before the rear end of the medium has passed the positions of the third conveyance roller 118 and the fourth conveyance roller 119. The control unit 141 determines that the leading end of the medium has passed the position of the discharge port when a second predetermined time has elapsed since the leading end of the medium passed the position of the second media sensor 116. The second predetermined time is set to the time taken for the medium to move from the position of the second media sensor 116 to the position of the discharge port. The control unit 141 determines that the rear end of the medium has passed the positions of the third conveyance roller 118 and the fourth conveyance roller 119 when a third predetermined time has elapsed since the rear end of the medium passed the positions of the second media sensor 116. The third predetermined time is set to the time taken for the medium to move from the position of the second media sensor 116 to the positions of the third conveyance roller 118 and the fourth conveyance roller 119.

As a result, the medium is held between the third conveyance roller 118 and the fourth conveyance roller 119 in a state where a portion of the medium is discharged from the discharge port. Therefore, the user can easily take out the medium for which the setting information is determined to be incompatible from the discharge port without opening the upper housing 102. Furthermore, the user can reliably recognize the medium for which the setting information is determined to be incompatible and keep the medium separate from other media. This allows the user to easily cause the media conveying apparatus 100 to re-convey and re-image the medium not in compatible with the setting information. Thus, the media conveying apparatus 100 can increase convenience for the user. The control unit 141 may suspend conveying the medium in a state where the rear end of the medium has passed the positions of the third conveyance roller 118 and the fourth conveyance roller 119, that is, all the media have been discharged from the discharge port. In this case, the user recognizes the top medium on the discharge table 104 as a medium that is incompatible with the setting information.

Next, the identifying unit 144 identifies the setting information that is compatible with the medium for which the setting information is determined to be incompatible (step S108). The identifying unit 144 identifies the setting information that is compatible with the medium based on the determination result determined by the determination unit 143 for the item determined to be incompatible by the determination unit 143 in step S106.

For example, in a case where the determination unit 143 determines that the resolution item is incompatible, the identifying unit 144 identifies the setting information that is compatible with the medium for the resolution item. In a case where the determination unit 143 determines that the input image includes image data other than text or ruled lines, the identifying unit 144 identifies a resolution that is larger than the first resolution threshold (for example, 200 dpi) as the setting information that is compatible with the medium. In that case, the identifying unit 144 may identify the maximum resolution supported by the media conveying apparatus 100 as the setting information that is compatible with the medium. By contrast, in a case where the determination unit 143 determines that the input image does not include image data other than text or ruled lines, the identifying unit 144 identifies a resolution that is less than the second resolution threshold (for example, 600 dpi) as the setting information that is compatible with the medium. In that case, the identifying unit 144 may identify the minimum resolution supported by the media conveying apparatus 100 as the setting information that is compatible with the medium.

Further, in a case where the determination unit 143 determines that the color item is incompatible, the identifying unit 144 identifies the setting information that is compatible with the medium for the color item. In a case where the determination unit 143 determines that the input image includes image data other than text or ruled lines, the identifying unit 144 identifies color or grayscale as the setting information that is compatible with the medium. By contrast, in a case where the determination unit 143 determines that the input image does not include image data other than text or ruled lines, the identifying unit 144 identifies grayscale or binary as the setting information that is compatible with the medium.

Further, in a case where the determination unit 143 determines that the media size item is incompatible, the identifying unit 144 identifies the setting information that is compatible with the medium for the media size item. The identifying unit 144 identifies the size of the medium calculated in step S106 as the setting information that is compatible with the medium.

Further, in a case where the determination unit 143 determines that the background color item is incompatible, the identifying unit 144 identifies the setting information that is compatible with the medium for the background color item. In a case where the determination unit 143 determines that the show-through of the medium has occurred, the identifying unit 144 identifies black as the setting information that is compatible with the medium.

Next, the identifying unit 144 determines whether the setting information identified as the setting information that is compatible with the medium is supported by the media conveying apparatus 100 (step S109). In a case where the identified setting information is supported by the media conveying apparatus 100, the identifying unit 144 moves the process to step S112 without executing any particular process.

By contrast, in a case where the identified setting information is not supported by the media conveying apparatus 100, the acquisition unit 145 acquires capability information indicating the respective capabilities of other media conveying apparatuses or other software regarding imaging processing or image processing (step S110). Other media conveying apparatuses are media conveying apparatuses other than the media conveying apparatus 100 included in the image processing system 1, and other software is software other than the software installed on the media conveying apparatus 100 included in the image processing system 1. The software is driver software or the like that causes the media conveying apparatus 100 to execute each process. The capability information indicates, for each item specified in the setting information, the functions that the media conveying apparatus or software can perform (the content of the operation in imaging the media or the content of the image processing to be executed on the obtained image). The capability information of each media conveying apparatus or each software included in the image processing system 1 is stored in advance in the second storage device 210 of the information processing apparatus 200 or a storage device of an external server device. The acquisition unit 145 acquires the capability information of each media conveying apparatus or each software by receiving the capability information from the information processing apparatus 200 or the external server device via the first communication device 122.

Next, the identifying unit 144 identifies a media conveying apparatus or software that has the capability of being compatible with the medium for which the setting information is determined to be incompatible, from among other media conveying apparatuses or other software (step S111). The identifying unit 144 identifies the media conveying apparatus or software having the capability information that can correspond to the setting information identified in step S108 as the media conveying apparatus or software that has the capability compatible with the medium for which the setting information is determined to be incompatible.

Next, the notification unit 146 generates the first notification data for notifying the user that the setting information is incompatible with the conveyed medium. The notification unit 146 outputs, to the user, the generated first notification data by displaying the generated first notification data on the first display device 106 or by transmitting the generated first notification data to the information processing apparatus 200 via the first communication device 122 (step S112). The information processing apparatus 200 causes the second display device 202 to display the received first notification data in a case where the information processing apparatus 200 receives the first notification data from the media conveying apparatus 100 via the second communication device 203. The first notification data is an example of information about the determination result by the determination unit 143.

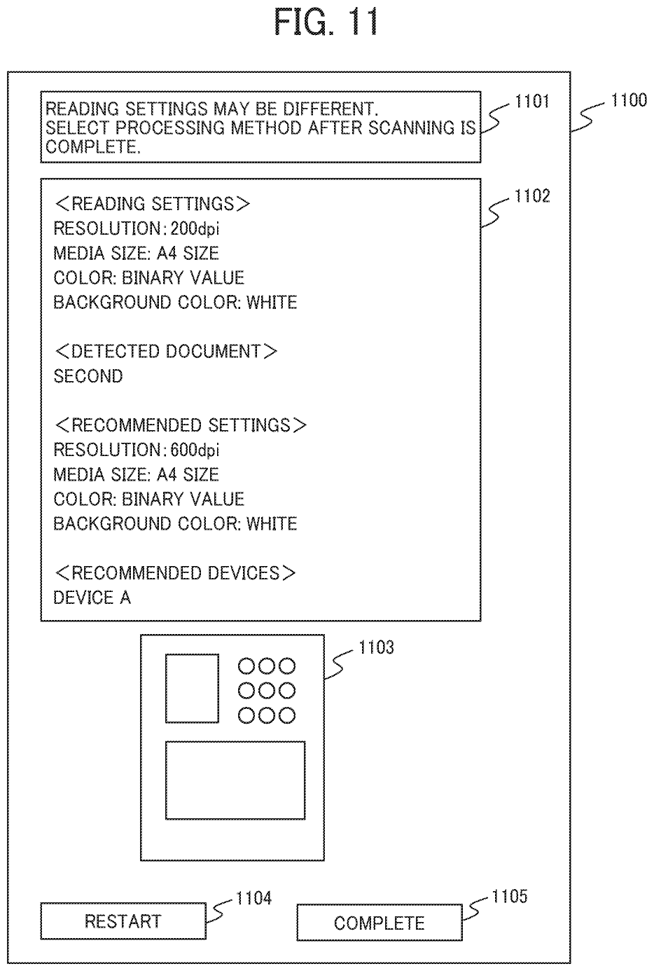

FIG. 11 is a schematic diagram illustrating an example of a first notification data 1100.

As illustrated in FIG. 11, the first notification data 1100 includes a summary information 1101, a detailed information 1102, an image 1103, a restart button 1104, and an end button 1105. The summary information 1101 indicates the determination result by the determination unit 143, that is, the setting information set by the user is incompatible with the conveyed medium, and indicates that rescanning of the conveyed medium is recommended. The detailed information 1102 indicates the setting information set by the user, the media number of the medium for which the setting information is incompatible, the recommended setting that is compatible with the medium, and the recommended apparatus or software that supports the recommended setting compatible with the medium. The recommended setting is specific information identified by the identifying unit 144 as the setting information compatible with the medium for which the setting information is determined to be incompatible. The recommended device or recommended software is identified by the identifying unit 144 as a media conveying apparatus or software that has the capability of being compatible with the medium for which the setting information is determined to be incompatible.

In this manner, the notification unit 146 notifies the user of the specific information identified by the identifying unit 144 as the setting information compatible with the medium for which the setting information is determined to be incompatible. This allows the user to recognize the appropriate settings for the medium, and to re-convey and re-image the medium in accordance with the settings. Therefore, the media conveying apparatus 100 can improve convenience for the user.

Furthermore, the notification unit 146 outputs information about a media conveying apparatus or software that has the capability of being compatible with the medium for which the setting information is determined to be incompatible, from among other media conveying apparatuses or other software. As a result, the user can recognize a media conveying apparatus or software that can generate an image suitable for the conveyed medium, and can obtain a desired image using the media conveying apparatus or software. Therefore, the media conveying apparatus 100 can improve convenience for the user.

The image 1103 is an input image in which the medium is imaged or an image processed based on the input image. By viewing the image 1103, the user can confirm the image of the conveyed medium captured or processed according to the setting information, and can confirm the validity of the setting information. The restart button 1104 is a button for restarting conveying the media. By pressing the restart button 1104 after taking out the conveyed medium, the user can restart conveying and imaging the remaining media according to the currently set setting information. The end button 1105 is a button for ending the media reading process. By pressing the end button 1105, the user can cancel the conveying and imaging of the remaining media according to the currently set setting information.

Subsequently, the reception unit 147 stands by until an instruction to restart or end the conveying and imaging of the medium is input by the user using the first input device 105 or the information processing apparatus 200, and the first instruction signal is received from the first input device 105 or the first communication device 122 (step S113). In a case where the restart button 1104 is pressed by the user, the reception unit 147 receives the first instruction signal from the first input device 105 or the first communication device 122 that instructs to restart the conveying and imaging the media. By contrast, in a case where the end button 1105 is pressed by the user, the reception unit 147 receives the first instruction signal from the first input device 105 or the first communication device 122 that instructs to end the conveying and imaging of the media.

In a case where the reception unit 147 receives the first instruction signal, the reception unit 147 determines whether the first instruction signal instructs to restart or end the conveying and imaging of the media (step S114). In a case where the instruction is given to end the conveying and imaging of the media, the control unit 141 ends the media reading process without conveying the remaining media.

By contrast, in a case where the instruction is given to restart the conveying and imaging of media, the control unit 141 re-starts the motor 121 and re-rotates the feeding roller 112, the separation roller 113, the first conveyance roller 114, the second conveyance roller 115, the third conveyance roller 118, and/or the fourth conveyance roller 119. Thereby, the control unit 141 controls the remaining media placed on the receptacle 103 to be conveyed (step S115).

Next, the control unit 141 determines whether the media remains on the receptacle 103 based on the first media signal received from the first media sensor 111 (step S116). In a case where the media remains on the receptacle 103, the control unit 141 increments (+1) the media number of the medium to be conveyed, and sets the media number of the next media to be conveyed. Then, the control unit 141 returns the process to step S105 and repeats the processes of steps S105 to S116.

By contrast, in a case where no media remains on the receptacle 103, the control unit 141 stops the motor 121 to stop the feeding roller 112, the separation roller 113, the first conveyance roller 114, the second conveyance roller 115, the third conveyance roller 118, and the fourth conveyance roller 119 (step S117). Thereby, the control unit 141 stops the conveying of the media.

Next, the control unit 141 determines whether a medium for which the setting information is determined to be incompatible by the determination unit 143 in step S106 exists (step S118). In a case where no media exist for which the setting information is determined to be incompatible, the control unit 141 ends the media reading process.

By contrast, when there is a medium for which the setting information is determined to be incompatible, the notification unit 146 generates the second notification data to receive instructions on whether to re-imaging the medium for which the setting information is determined to be incompatible. The notification unit 146 outputs, to the user, the generated second notification data by displaying the generated second notification data on the first display device 106 or by transmitting the generated second notification data to the information processing apparatus 200 via the first communication device 122 (step S119). The information processing apparatus 200 causes the second display device 202 to display the received second notification data in a case where the information processing apparatus 200 receives the second notification data from the media conveying apparatus 100 via the second communication device 203. The second notification data is an example of information about the determination result by the determination unit 143.

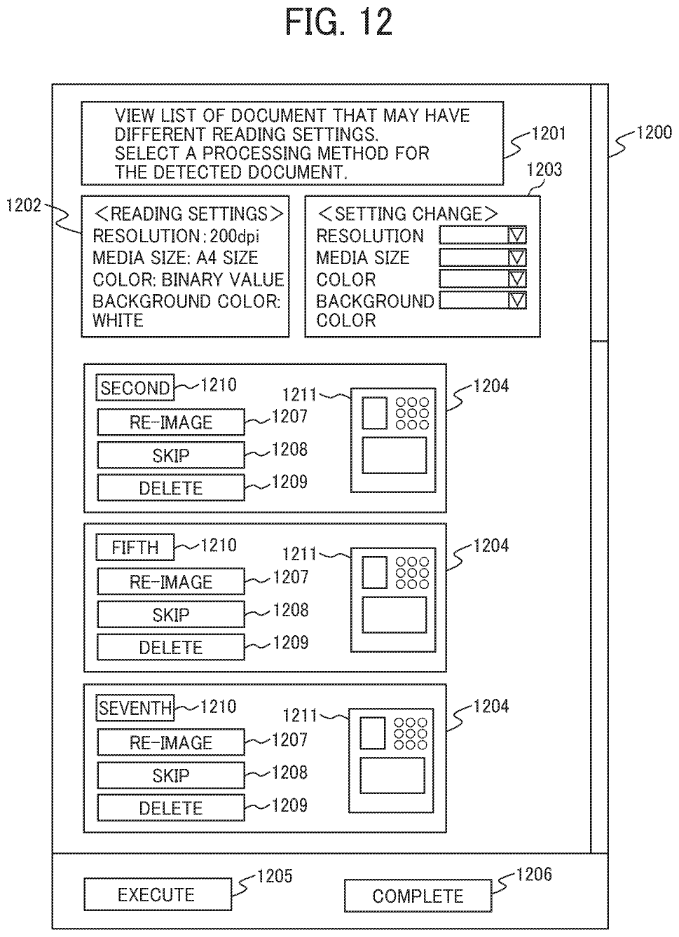

FIG. 12 is a schematic diagram illustrating an example of a second notification data 1200.

As illustrated in FIG. 12, the second notification data 1200 includes a summary information 1201, a detailed information 1202, a setting change object 1203, a processing designation object 1204, an execution button 1205, and an end button 1206. The summary information 1201 indicates the determination result by the determination unit 143, that is, there is a medium incompatible with the setting information set by the user, and that rescanning of the conveyed medium is recommended. The detailed information 1202 indicates the setting information and the like set by the user. The setting change object 1203 is an object for receiving changes in the setting information by the user, and includes a box for inputting the setting values designated by the user for each item included in the setting information.

The processing designation object 1204 is an object for receiving the designation by the user of processing for each medium for which the setting information is incompatible, and is displayed for each medium for which the setting information is determined to be incompatible in step S106. Each processing designation object 1204 includes a re-imaging button 1207, a skip button 1208, a delete button 1209, a media number 1210, and an image 1211. The re-imaging button 1207 is a button for re-conveying and re-imaging the corresponding media. By pressing the re-imaging button 1207, the user can cause the re-conveying and re-imaging of the corresponding media to be executed according to the setting information specified by the setting change object 1203. The skip button 1208 is a button for skipping the re-conveying and re-imaging of the corresponding media. By pressing the skip button 1208, the user can skip the re-conveying and re-imaging of the corresponding media. The delete button 1209 is a button for deleting a processed image in which the corresponding medium is imaged. By pressing the delete button 1209, the user can delete the processed image in which the corresponding medium is imaged. The media number 1210 is the media number of the corresponding media. The image 1211 is the input image in which the corresponding medium is imaged, or the processed image based on the input image. The user can confirm the image 1211 of the conveyed medium imaged or processed according to the setting information, and can refer to the image 1211 to decide whether to re-image the media.

The processing designation objects 1204 are displayed in the order in which the media are conveyed. Accordingly, the media conveying apparatus 100 can make the user aware that one or more media to be re-conveyed and re-imaged should be placed again on the receptacle 103 in the order in which the medium has been initially conveyed. Thus, the media conveying apparatus 100 can convey the media to be re-conveyed and re-imaged in the order in which the media has been initially conveyed, and can properly replace images obtained with inappropriate settings with images reobtained. The notification unit 146 may display a screen in which the image, in which each medium to be executed for re-conveying and re-imaging is imaged, is lined up according to the order in which each medium is initially conveyed, and may explicitly request the user to re-place each medium on the receptacle 103 according to the order in which each medium is initially conveyed.

The execution button 1205 is a button for executing the process designated by each processing designation object 1204. By pressing the execution button 1205, the user can cause the process designated by the processing designation object 1204 to be executed for each medium for which the setting information is incompatible. The end button 1206 is a button for ending the media reading process. By pressing the end button 1206, the user can end the media reading process.

Next, the reception unit 147 stands by until a processing instruction or an end instruction is input by the user using the first input device 105 or the information processing apparatus 200, and a second instruction signal is received from the first input device 105 or the first communication device 122 (step S120).

When the user presses the execution button 1205, the reception unit 147 receives the second instruction signal from the first input device 105 or the first communication device 122 that instructs to process the medium for which the setting information is incompatible. The second instruction signal that instructs to process the medium for which the setting information is incompatible includes the setting information input to the setting change object 1203. The second instruction signal that instructs to process the medium for which the setting information is incompatible includes the media number of the medium to be re-conveyed and re-imaged, the media number of the medium to be skipped in re-conveying and re-imaging, and/or the media number of the medium corresponding to the processed image to be deleted. The media number of the medium to be re-conveyed and re-imaged is the media number of the medium corresponding to the processing designation object 1204 for which the re-imaging button 1207 is pressed by the user. The media number of the medium to be skipped in re-conveying and re-imaging is the media number of the media corresponding to the processing designation object 1204 for which the skip button 1208 is pressed by the user. The media number of the medium corresponding to the processed image to be deleted is the media number of the medium corresponding to the processing designation object 1204 for which the delete button 1209 is pressed by the user.

By contrast, in a case where the end button 1206 is pressed by the user, the reception unit 147 receives the second instruction signal from the first input device 105 or the first communication device 122 that instructs to end the conveying and imaging of the media.

In this manner, the reception unit 147 receives an instruction from the user indicating whether to re-image the medium in which the setting information is determined to be incompatible. This allows the user to have the medium re-imaged to obtain the appropriate processed image when the medium is incompatible with the setting information, and saves the user's trouble of having the media re-imaged when the setting information is appropriate. Therefore, the media conveying apparatus 100 can improve convenience for the user.

The reception unit 147 receives an instruction from the user whether to delete the processed image from the first storage device 130 and/or the second storage device 210 in which the processed image that includes the medium for which the setting information is determined to be incompatible is stored. Thereby, the user can delete the processed image having been generated according to inappropriate setting information, and can prevent such an inappropriate image from remaining. Therefore, the media conveying apparatus 100 can improve convenience for the user.

When the reception unit 147 receives the second instruction signal, the reception unit 147 determines whether the second instruction signal instructs to process the medium for which the setting information is incompatible or instructs to end the conveying and imaging of the media (step S121). When the second instruction signal instructs to end the conveying and imaging of the media, the control unit 141 ends the media reading process.

By contrast, in a case where the second instruction signal instructs to process the medium for which the setting information is incompatible, the reception unit 147 determines whether the second instruction signal instructs to delete the processed image (step S122). In a case where the second instruction signal does not instruct to delete the processed image, the control unit 141 controls to moves the process to step S124 without executing any particular process.

By contrast, when the second instruction signal instructs to delete the processed image, the control unit 141 deletes the input image and/or the processed image stored in association with the media number of the media specified in the result table to delete the corresponding processed image according to the second instruction signal. Further, the control unit 141 transmits a deletion request signal requesting deletion of the processed image to the information processing apparatus 200 via the first communication device 122. The deletion request signal includes a media number corresponding to the processed image to be deleted. In a case where the second processing circuit 220 of the information processing apparatus 200 receives the deletion request signal from the media conveying apparatus 100 via the second communication device 203, the second processing circuit 220 deletes the processed image associated with the media number included in the deletion request signal from the second storage device 210 (step S123). This processing is advantageous when a medium not to be processed is mixed in the media conveyed collectively. This processing saves the user from having to find and delete the input image and/or the processed image of the medium not to be processed among the images of the media conveyed collectively. Therefore, the media conveying apparatus 100 can improve convenience for the user.

Next, the reception unit 147 determines whether the second instruction signal instructs to re-convey and re-image the medium (step S124). When the second instruction signal does not instruct to re-convey and re-image the medium, the control unit 141 ends the media reading process without executing any particular process.

By contrast, in a case where the second instruction signal instructs to re-convey and re-image the media, the control unit 141 returns the process to step S102 and executes the subsequent processes from step S102. In this case, the user re-places the medium specified to be executed for re-conveying and re-imaging on the receptacle 103. In step S102, the setting unit 142 acquires the setting information included in the second instruction signal and sets the setting information to the imaging device 117, the motor 121, and the like so that the input image is generated according to each setting indicated in the acquired setting information. In step S104, the control unit 141 controls the motor 121 so that the input image is generated according to the setting information acquired in step S102. In step S105, the control unit 141 controls the imaging device 117 so that the input image is generated according to the setting information acquired in step S102, and executes image processing on the input image according to the setting information acquired in step S102 to generate the processed image.

The control unit 141 refers to each medium number included in the second instruction signal and identifies the media number of the medium, that is, the media number when the medium is initially conveyed, according to the ordinal number of the medium in the re-conveying. In the result table, the control unit 141 replaces the input image and the processed image stored in association with the identified media number with the newly acquired input image and the newly generated processed image. The control unit 141 sends the newly generated processed image and a replacement request signal requesting the replacement of the processed image stored in the second storage device 210 with the newly generated processed image to the information processing apparatus 200 via the first communication device 122. The replacement request signal includes the media number corresponding to the processed image to be replaced. In a case where the second processing circuit 220 of the information processing apparatus 200 receives the replacement request signal from the media conveying apparatus 100 via the second communication device 203, the second processing circuit 220 replaces the processed image associated with the media number included in the replacement request signal with the newly received processed image.

Thus, in a case where the control unit 141 re-images a medium for which the setting information is determined to be incompatible to reobtains the input image, the control unit 141 replaces a processed image with the reobtained processed image in the first storage device 130 and/or the second storage device 210 in which the processed image including that medium is stored. This eliminates the need for the user to search for a processed image generated according to incorrect setting information and replace the processed image with a re-imaged processed image, and the media conveying apparatus 100 can improve convenience for the user.

The processing of step S108, steps S109 to S111, step S112, step S119, step S120, step S121, steps S122 to S123, and/or step S124 may be omitted.

As detailed above, the media conveying apparatus 100 determines whether the setting information is compatible with the medium imaged in the input image, and, in the case of being not compatible, the media conveying apparatus 100 suspends conveying subsequent media and performs notification to the user. This enables the media conveying apparatus 100 to improve convenience for the user.

A bundle of media of mixed media types may be conveyed collectively. For example, a photograph is mixed in a bundle of forms. In this case, it is possible that an image is generated from a captured image of another type of medium (for example, a photograph) according to the settings suitable for a particular type of medium (for example, binary values suitable for forms). In such a case, the user has to pull out a medium that is imaged with inappropriate settings from the bundle of media, have the bundle of media re-conveyed and re-imaged, and replace the image generated with the inappropriate settings with the newly generated image. It is also possible that the user is unaware of the medium imaged with inappropriate settings and an image generated with inappropriate settings remains. When the setting information is incompatible with the conveyed medium, the media conveying apparatus 100 suspends conveying subsequent media, allowing the user to take measures such as pulling out the medium at that point. In addition, when the setting information is incompatible with the conveyed medium, the media conveying apparatus 100 notifies the user of that, thereby allowing the user to cause the media conveying apparatus 100 to re-convey and re-image the medium with the appropriate settings. Therefore, the media conveying apparatus 100 can improve convenience for the user.

Further, even in a case where the user has low knowledge or skill regarding image reading processing, the user can appropriately select setting information, another media conveying apparatus, or another software that can generate a desired image. This allows the media conveying apparatus 100 to prevent the occurrence of rework in the image reading process due to the use of inappropriate settings, media conveying apparatus 100, or software, thereby minimizing the decrease in the work efficiency or the work quality of the user.

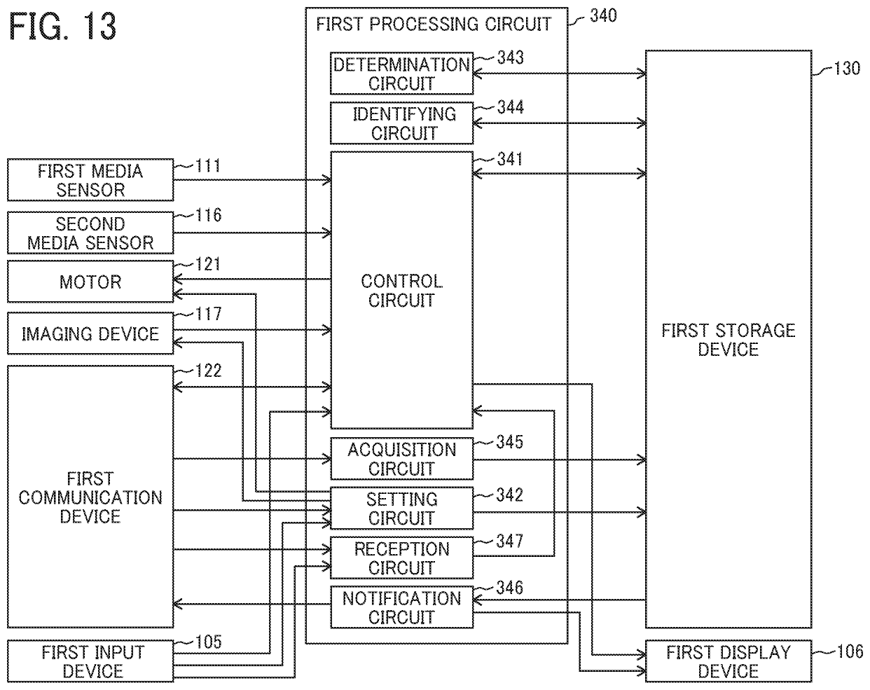

FIG. 13 is a block diagram illustrating a schematic configuration of a first processing circuit 340 in a media conveying apparatus according to another embodiment.

The first processing circuit 340 is used in place of the first processing circuit 140 and executes media reading process and the like. The first processing circuit 340 includes a control circuit 341, a setting circuit 342, a determination circuit 343, an identifying circuit 344, an acquisition circuit 345, a notification circuit 346, a reception circuit 347, and the like.

The control circuit 341 is one example of a control unit and functions like the control unit 141. The control circuit 341 receives the operation signal from the first input device 105 or the first communication device 122, the first instruction signal or the second instruction signal from the reception circuit 347, the first media signal from the first media sensor 111, and the second media signal from the second media sensor 116. The control circuit 341 also reads from the first storage device 130 the determination result indicating whether the setting information is compatible with the medium imaged in the input image. The control circuit 341 controls the motor 121 based on the respective information received or read. The control circuit 341 acquires the input image from the imaging device 117, generates the processed image based on the input image, stores the processed image in the first storage device 130, and outputs the processed image to the first display device 106 or the first communication device 122.

The setting circuit 342 is one example of a setting unit and functions like the setting unit 142. The setting circuit 342 receives the setting information from the first input device 105 or the first communication device 122, stores the setting information in the first storage device 130, and sets the setting information to the imaging device 117 or the motor 121.

The determination circuit 343 is one example of a determination unit and functions like the determination unit 143. The determination circuit 343 reads the setting information and the input image from the first storage device 130, determinates whether the setting information is compatible with the medium imaged in the input image based on the input image, and stores the determination result in the first storage device 130.

The identifying circuit 344 is one example of an identifying unit and functions like the identifying unit 144. The identifying circuit 344 reads the input image from the first storage device 130, identifies the setting information compatible with the medium imaged in the input image, and stores the identified result in the first storage device 130. The identifying circuit 344 reads the setting information and the capability information from the first storage device 130, identifies the media conveying apparatus or software that has the capability compatible with the medium, and stores the identified result in the first storage device 130.

The acquisition circuit 345 is one example of an acquisition unit and functions like the acquisition unit 145. The acquisition circuit 345 receives the capability information from the first communication device 122 and stores the capability information in the first storage device 130.

The notification circuit 346 is one example of a notification unit and functions like the notification unit 146. The notification circuit 346 reads from the first storage device 130 the determination result by the determination circuit 343 and the identified result by the identifying circuit 344, and outputs the determination result and the identified result to the first display device 106 or the first communication device 122.

The reception circuit 347 is one example of a reception unit and functions like the reception unit 147. The reception circuit 347 receives the first instruction signal or the second instruction signal from the first input device 105 or the first communication device 122 and outputs the first instruction signal or the second instruction signal to the control circuit 341.

As detailed above, the media conveying apparatus increases the convenience for the user also when the first processing circuit 340 is used.

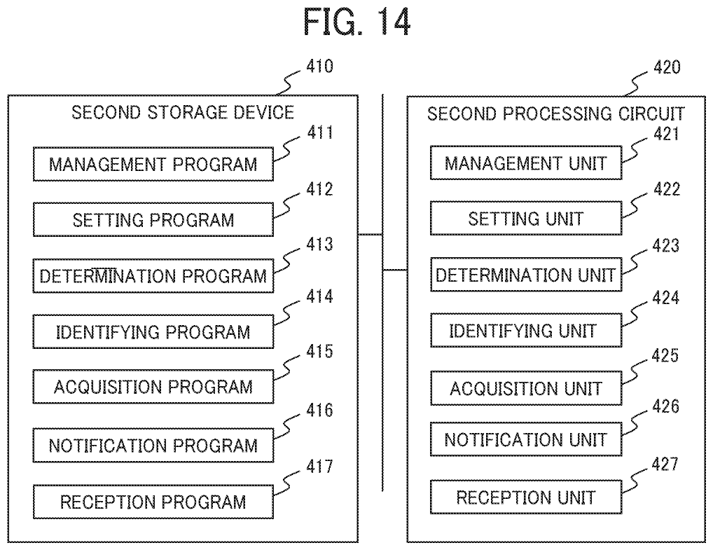

FIG. 14 is a diagram illustrating a schematic configuration of a second storage device 410 and a second processing circuit 420 in an information processing apparatus according to still another embodiment.

As illustrated in FIG. 14, the second storage device 410 stores a management program 411, a setting program 412, a determination program 413, an identifying program 414, an acquisition program 415, a notification program 416, and a reception program 417. Each of these programs is a functional module implemented by software operating on a processor. The second processing circuit 420 reads each program stored in the first storage device 130 and operates according to each program read, thereby functioning as a management unit 421, a setting unit 422, a determination unit 423, an identifying unit 424, an acquisition unit 425, a notification unit 426 and a reception unit 427. The setting unit 422, the determination unit 423, the identifying unit 424, the acquisition unit 425, the notification unit 426, and the reception unit 427 have the same functions as the setting unit 142, the determination unit 143, the identifying unit 144, the acquisition unit 145, the notification unit 146, and the reception unit 147 of the media conveying apparatus 100, respectively. The second storage device 410 stores each data stored by the first storage device 130.

In a case where the media reading process is executed in the present embodiment, in step S101, the management unit 421 stands by until a reading instruction to read the media is input by the user using the second input device 201 and an operation signal is received from the second input device 201. The management unit 421 transmits the received operation signal to the media conveying apparatus 100 via the second communication device 203.

In step S102, the setting unit 422 acquires the setting information included in the operation signal and sends a request signal to the media conveying apparatus 100 via the second communication device 203 requesting that the input image be generated according to each setting indicated in the acquired setting information. The setting unit 142 of the media conveying apparatus 100 receives the request signal from the information processing apparatus 200 via the first communication device 122 and sets the setting information to the imaging device 117, the motor 121, and the like so that the input image is generated according to each setting specified in the request signal. This allows the setting unit 422 to set the setting information designated by the user.

In step S105, the control unit 141 transmits the input image and the processed image to the information processing apparatus 200 via the first communication device 122. The management unit 421 receives the input image and the processed image from the media conveying apparatus 100 via the second communication device 203 and stores the input image and the processed image in the result table of the second storage device 410.

In step S106, the determination unit 423 determines, based on the input image, whether the setting information set by the user is compatible with the medium imaged in the input image. The determination unit 423 stores the determination result in the result table of the second storage device 410 and transmits the determination result to the media conveying apparatus 100 via the second communication device 203. The determination unit 143 of the media conveying apparatus 100 receives the determination result from the information processing apparatus 200 via the first communication device 122.

In step S108, the identifying unit 424 identifies the setting information that is compatible with the medium for which the setting information is determined to be incompatible. In step S109, the identifying unit 424 determines whether the setting information identified as setting information that is compatible with the medium is supported by the media conveying apparatus 100. In step S110, the acquisition unit 425 acquires capability information indicating the respective capabilities of other media conveying apparatuses or other software regarding imaging processing or image processing. In step S111, the identifying unit 424 identifies a media conveying apparatus or software that has the capability of being compatible with the medium for which the setting information is determined to be incompatible, from among other media conveying apparatuses or other software.

In step S112, the notification unit 426 generates the first notification data and outputs, to the user, the generated first notification data by displaying the generated first notification data on the second display device 202. In this manner, the notification unit 426 outputs, to the user, the specific information identified by the identifying unit 424 as the setting information that is compatible with the medium for which the setting information is determined to be incompatible. The notification unit 426 outputs information about a media conveying apparatus or software that has the capability of being compatible with the medium for which the setting information is determined to be incompatible, from among other media conveying apparatuses or other software.

In step S113, the reception unit 427 stands by until an instruction to restart or end the conveying and imaging of the media is input by the user using the second input device 201 and the first instruction signal is received from the second input device 201. The reception unit 427 transmits the received first instruction signal to the media conveying apparatus 100 via the second communication device 203.

In step S118, the management unit 421 determines whether a medium exists in which the setting information is determined to be incompatible by the determination unit 423 in step S106. In step S119, the notification unit 426 generates the second notification data and outputs, to the user, the generated second notification data by displaying the generated second notification data on the second display device 202.

In step S120, the reception unit 427 stands by until a processing instruction or an end instruction is input by the user using the second input device 201 and the second instruction signal is received from the second input device 201. The reception unit 427 transmits the received second instruction signal to the media conveying apparatus 100 via the second communication device 203. In this manner, the reception unit 427 receives an instruction from the user indicating whether to re-image the medium in which the setting information is determined to be incompatible. The reception unit 427 receives an instruction from the user indicating whether to delete the processed image from the second storage device 210 in which the processed image that includes the medium for which the setting information is determined to be incompatible is stored.

Some of the processes executed by each unit of the information processing apparatus described above may be executed by the corresponding unit of the media conveying apparatus.

As detailed above, the image processing system has made it possible to improve convenience for the user also when the information processing apparatus executes some of the media reading processes.

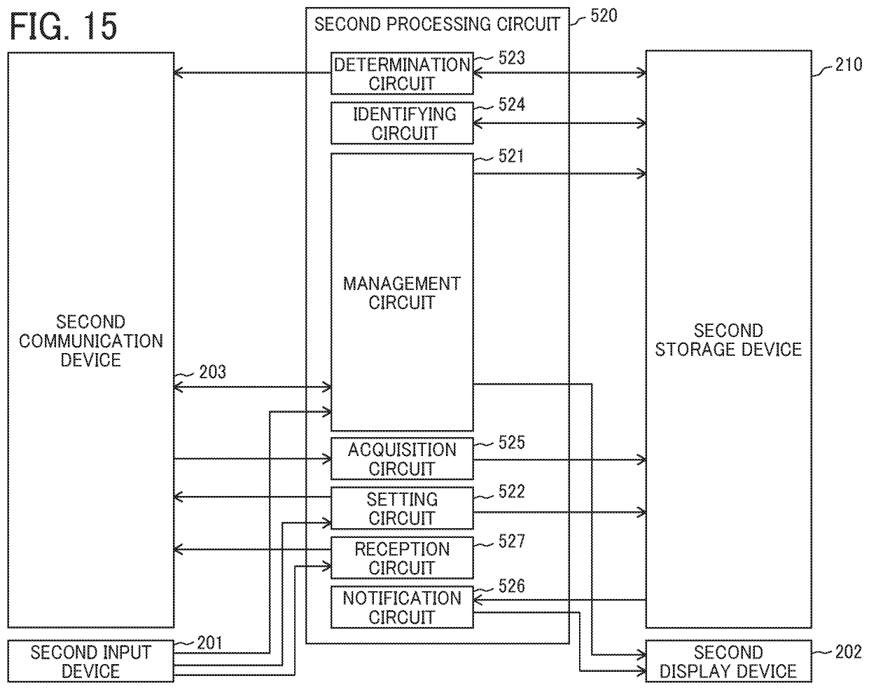

FIG. 15 is a block diagram illustrating a schematic configuration of a second processing circuit 520 in the information processing apparatus according to still another embodiment.

The second processing circuit 520 is used in place of the second processing circuit 420 and executes media reading process and the like. The second processing circuit 520 includes a management circuit 521, a setting circuit 522, a determination circuit 523, an identifying circuit 524, an acquisition circuit 525, a notification circuit 526, and a reception circuit 527.

The management circuit 521 is one example of a management unit and functions like the management unit 421. The management circuit 521 receives an operation signal from the second input device 201 and outputs the received operation signal to the second communication device 203. The management circuit 521 receives the input image and the processed image from the second communication device 203, stores the input image and the processed image in the second storage device 210, and outputs the input image and the processed image to the second display device 202.

The setting circuit 522 is one example of a setting unit and functions like the setting unit 422. The setting circuit 522 receives the setting information from the second input device 201, stores the setting information in the second storage device 210, and outputs the setting information to the second communication device 203.

The determination circuit 523 is one example of a determination unit and functions like the determination unit 423. The determination circuit 523 reads the setting information and the input image from the second storage device 210, determinates whether the setting information is compatible with the medium imaged in the input image based on the input image, stores the determination result in the second storage device 210, and outputs the determination result to the second communication device 203.

The identifying circuit 524 is one example of an identifying unit and functions like the identifying unit 424. The identifying circuit 524 reads the input image from the second storage device 210, identifies the setting information compatible with the medium imaged in the input image, and stores the identified result in the second storage device 210. The identifying circuit 524 reads the setting information and the capability information from the second storage device 210, identifies the media conveying apparatus or software that has the capability compatible with the medium, and stores the identified result in the second storage device 210.

The acquisition circuit 525 is one example of an acquisition unit and functions like the acquisition unit 425. The acquisition circuit 525 receives the capability information from the second communication device 203 and stores the capability information in the second storage device 210.

The notification circuit 526 is one example of a notification unit and functions like the notification unit 426. The notification circuit 526 reads from the second storage device 210 the determination result by the determination circuit 523 and the identified result by the identifying circuit 524, and outputs the determination result and the identified result to the second display device 202.

The reception circuit 527 is one example of a reception unit and functions like the reception unit 427. The reception circuit 527 receives the first instruction signal or the second instruction signal from the second input device 201 and outputs the first instruction signal or the second instruction signal to the second communication device 203.

As detailed above, the information processing apparatus has made it possible to improve convenience for the user also when the second processing circuit 520 is used.

Although the preferred embodiments have been described above, the embodiments are not limited thereto. For example, after the control unit 141 stops the conveying of the media in step S107 of FIG. 9, the control unit 141 may proceed to step S115 to restart feeding and conveying of the remaining media when the medium is pulled out of the media conveying path by the user. In that case, a media sensor is provided between each of the third conveyance roller 118 and the fourth conveyance roller 119, and the discharge port, and the control unit 141 determines whether any medium remains in the media conveying path based on the output signal from the media sensor. This eliminates the need for the user to perform an operation to input a restart instruction, and the media conveying apparatus 100 can further improve convenience for the user.

When the medium is re-conveyed and re-imaged, the control unit 141 may determine in step S105 of FIG. 9 whether the medium in the newly generated input image is identical to the medium in the original input image. In that case, the control unit 141 calculates the degree of similarity between the newly generated input image and the original input image. The degree of similarity is, for example, normalized cross-correlation. When the degree of similarity is equal to or greater than the degree of similarity threshold, the control unit 141 determines that the two input image include an identical medium and sends the input image and the processed image to the information processing apparatus 200. By contrast, when the degree of similarity is less than the degree of similarity threshold, the control unit 141 determines that the medium is different between the two input images and outputs, to the user, a warning by displaying the warning on the first display device 106 or by transmitting the warning to the information processing apparatus 200 via the first communication device 122.

The determination unit 143 may determine whether the setting information is compatible with the medium imaged in the input image using only a portion of the input image (a portion of the top side), rather than using the entire input image. In that case, the determination unit 143 executes the determination process of step S106 when the control unit 141 acquires the input image for a predetermined number of lines from the imaging device 117. This allows the media conveying apparatus 100 to determine earlier whether the setting information is compatible with the medium imaged in the input image.

The media conveying apparatus may also have a so-called U-turn path, feeding and conveying media placed on the receptacle from the top side in sequence and discharging the media to the discharge table.

Any one of the above-described operations may be performed in various other ways, for example, in an order different from the one described above. The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

In one aspect, a program for controlling a computer includes a plurality of program codes which, when executed by the computer, causes the computer to perform a method including:
setting setting information designated by a user regarding an input image generation process;
determining, based on an input image, whether the setting information is compatible with a medium imaged in the input image, where the input image is generated by imaging each of the plurality of media sequentially conveyed according to the setting information;
suspending conveying subsequent media based on a determination result indicating that the setting information is incompatible with the medium imaged in the input image; and
outputting information about the determination result based on the determination result to the user.

1. A media conveying apparatus comprising:
circuitry configured to set setting information regarding an input image generation process;
a conveyor to convey a plurality of media sequentially; and
an imager to image each of the plurality of media according to the setting information to obtain an input image;
wherein the circuitry is further configured to determine, based on the input image, whether the setting information is compatible with a medium from the plurality of media imaged in the input image, and
wherein, when the circuitry determines that the setting information is incompatible with the medium imaged in the input image, the circuitry suspends conveying a subsequent media from the plurality of media and outputs information about the determination result.

2. The media conveying apparatus according to claim 1,
wherein, when the circuitry determines that the setting information is incompatible with the medium imaged in the input image, the circuitry further identifies setting information compatible with the medium and outputs the identified setting information.

3. The media conveying apparatus according to claim 1,
wherein the circuitry is configured to store an image based on the input image in a memory, and
wherein, when the medium for which the setting information is determined to be incompatible is re-imaged to reobtain an input image, the circuitry replaces the image stored in the memory with another image based on the reobtained input image.

4. The media conveying apparatus according to claim 1,
wherein the circuitry is further configured to receive an instruction indicating whether to re-image the medium for which the setting information is determined to be incompatible.

5. The media conveying apparatus according to claim 1,
wherein the circuitry is configured to:
store an image based on the input image in a memory; and
receive an instruction indicating whether to delete, from the memory, the image based on the input image for which the setting information is determined to be incompatible.

6. The media conveying apparatus according to claim 1,
wherein the circuitry is further configured to:
acquire capability information indicating respective capabilities of at least one of other media conveying apparatuses or other software, the capability information being information regarding an input image generation process; and
output information about a media conveying apparatus or software that has a capability compatible with the medium for which the setting information is determined to be incompatible, from among the other media conveying apparatuses or the other software.

7. An image processing system including a media conveying apparatus and an information processing apparatus, the system comprising:
circuitry configured to set setting information regarding an input image generation process,
a conveyor to convey a plurality of media sequentially; and
an imager to image each of the plurality of media according to the setting information to obtain an input image,
wherein the circuitry is further configured to determine, based on the input image, whether the setting information is compatible with a medium from the plurality of media imaged in the input image, and
wherein, when the circuitry determines that the setting information is incompatible with the medium imaged in the input image, the circuitry suspends conveying a subsequent media from the plurality of media and outputs information about the determination result.

8. A media conveying method comprising:
setting setting information regarding an input image generation process;
conveying a plurality of media sequentially by a conveyor;
imaging, with an imager, each of the plurality of media according to the setting information to obtain an input image;
determining, based on the input image, whether the setting information is compatible with a medium from the plurality of media imaged in the input image;
suspending conveying a subsequent media from the plurality of media based on a determination result indicating that the setting information is incompatible with the medium imaged in the input image; and
outputting information about the determination result based on the determination result.
